(19) United States
(12) Patent Application Publication
(10) Pub. No.: US 2014/0027511 A1
(43) Pub. Date: Jan. 30, 2014

(54) APPARATUS AND METHOD FOR SCANNING RFID-TAGGED ITEMS IN AN ENCLOSURE

(71) Applicants: Tom Plocher, Hugo, MN (US); Joseph Vargas, Santa Fe, NM (US); Ynjiun Paul Wang, Cupertino, CA (US)

(72) Inventors: Tom Plocher, Hugo, MN (US); Joseph Vargas, Santa Fe, NM (US); Ynjiun Paul Wang, Cupertino, CA (US)

(73) Assignee: Honeywell International Inc. d/b/a Honeywell Scanning and Mobility, Fort Mill, SC (US)

(21) Appl. No.: 13/560,424

(22) Filed: Jul. 27, 2012

(51) Int. Cl. G06K 7/10

(52) U.S. Cl. CPC G06K 7/10
USPC 235/439

(57) ABSTRACT

An apparatus and method for reading RFID tags utilizing a structure with an inner surface and an outer surface and a lateral input opening and a lateral output opening. In the structure, an RFID scanner mounted on the inner surface. This structure is positioned to enclose at least two sides of a lane. Items enter the lane via the lateral input opening and exit via the lateral output opening.

### FIELD OF INVENTION

The present invention provides a system and method for radio frequency identification (RFID) tracking for asset tracking, including at point of sale (POS).

### BACKGROUND OF INVENTION

Radio-frequency identification (RFID) uses radio-frequency electromagnetic fields in a wireless, no-contact system, to transfer data from a tag attached to an object. RFID tags contains electronically stored information which can be read from up to several meters away. Unlike a bar code, the tag does not need to be within line of sight of the reader and may be embedded in the tracked object.

RFID tags can be either passive, active or battery assisted passive. An active tag has an on-board battery that periodically transmits its ID signal. A battery assisted passive (BAP) has a small battery on board that is activated when in the presence of a RFID reader (also called an RFID scanner). A passive tag, the least expensive and most-common option, is cheaper and smaller because it has no battery.

A passive tag uses the radio energy transmitted by the reader as its energy source. The interrogator must be close for RF field to be strong enough to transfer sufficient power to the tag.

RFID scanners can distinguish between tags within a given range and read these tags simultaneously. Merchandise in stores is marked with bar codes, which are scanned at check out.

In retail environments, using RFID tags and scanners in place of bar codes and bar codes scanners presents some advantages over bar codes. For example, information can be transmitted from a tag to a receiver or reader from a distance, while bar code scanning requires direct contact with the bar coded item.

When checking out items at a retail establishment, merchandise with RFID tags need not be individually scanned; multiple items can be scanned at once. Bar codes require each individual item to be passed over a barcode reader.

Despite some advantages, scanning RFID tags at the point-of-sale (POS) is less reliable than scanning bar codes. In POS systems, every item must be scanned so that the customer is charged and the inventory is correct. Thus, RFID scanners do not deliver the reliability in tag reading necessary for checkout operations at POS.

The inefficiency in RFID tag scanning at POS is due primarily to two issues: 1) the tendency of RFID scanners to miss obscured tags and 2) the tendency of RFID scanners to inadvertently read unrelated tags.

The tendency of RFID scanners to miss obscured tags is a prominent issue at POS because a requirement of a POS system is that it have the ability to achieve reliable and consistent read rates while scanning mixed merchandise, especially in large quantities. Environmental factors that will cause an RFID scanner to miss a tag include, but are not limited to, one or more tags physically obscuring one or more other tags, for example, two or more tags becoming stacked on top of each other, interference in the radio transmission caused by metallic structures such as racks, fixtures and shopping carts, and the presence of liquids among the items waiting to be scanned. Regarding the latter example, liquids can dissipate RF signals and it is nearly impossible to reliably read a pallet stacked full of water bottles with RF technology.

Because an RFID scanner often inadvertently scans tags within close proximity that are not the intended targets, another issue related to checkout operations and RFID in general is that of inadvertent electronic product code (EPC) reconciliations. At POS because, tags from nearby checkout lanes can easily be read by accident, due to their close proximity. In other RFID operations, the mitigation strategy for this issue is to use pre-determined EPC lists generated by the inventory system to scan against. This effectively limits the items that can be reconciled to those that are identified within the EPC list, allowing unrelated RF tags to be within the read range of an RF device and not be reconciled. This limits RFID to a verification counting system because it can only reliably scan for known items (e.g. items that the inventory system expects to have on-hand). This method is not ideal for POS since people typically approach checkout lanes with baskets full of miscellaneous items. Thus, having pre-determined lists of EPCs is not currently feasible.

A need therefore exists for an effective way to utilize RFID scanning at in check out operations at POS.

### SUMMARY OF INVENTION

An object of the present invention is to enable an RFID scanner to read multiple tags efficiently and correctly.

Another object of the present invention is to utilize RFID tagging and scanning in a manner that encourages the scanning of all tags in a group of items in a checkout lane, including those items in positions that may be physically obscured by other items, physically obscured by environmental factors, and/or items comprised of materials, such as packaged liquids, that are difficult to scan using an RFID scanner.

Another object of the present invention is to utilize RFID tagging and scanning in a manner that reduces the unintentional scanning of items that are not being checked out at POS, for example, items that are in adjacent checkout lanes, while effectively scanning all the items that are being checked out at POS.

Another object of the present invention is to increase scan efficiency by simultaneously increasing read rates and decreasing inadvertent reconciliations.

Another object of the present invention is the enable the scanning of RFID tags on merchandise in a manner that supplies accurate data that can be used for inventory management.

An embodiment of the present invention utilizes a scan tunnel system comprising a checkout tunnel, a circular structure, surrounding a conveyer belt. This scan tunnel contains RF signals (to avoid inadvertent reconciliations) and reflects RF signals internally within the scan tunnel. The reflection of the RF signals in the tunnel allows multiple passes of RF waves over the RFID tags of the items on the conveyer belt. The checkout tunnel blocks out RF tags from adjacent checkout lanes.

In an embodiment of the present invention, one or more RFID readers is placed inside the RFID scan tunnel. The tunnel is covered by a shielding material on the outside and a material on the inside that reflects and scatters RF waves. The outside material and the tunnel itself prevents contamination from neighboring checkout lanes. The reflective material inside the tunnel creates an environment in which the RF signals reflect around and become multidirectional. In this embodiment, signals will strike tags from multiple directions and angles, increasing the chances for each individual tag to be read, including tags that are obscured from certain directions by environmental factors such as other tags and adjacent structures, such as the shopping cart.

In an embodiment of the present invention, the checkout tunnel is comprised of two segments, one slightly offset from the other. The two segments serve to minimize the potential for cross-contamination with signals from neighboring tunnels. Further embodiments of the present invention feature additional segments to accommodate the type of merchandise being scanned, the size of the conveyer belt, and additional environmental factors.

In another embodiment of the present invention, rather than a “tunnel” configuration, i.e., a spherical enclosure, two plates are oriented either on each side of the item(s) to be scanned or above and below the item(s). The area between the plates in open. As in the closed spherical embodiment, RFID readers is placed on the inner surfaces of the inside the RFID scan plates. The plates are covered by a shielding material on the outside and a material on the inside that reflects and scatters RF waves. The outside material and the plates themselves prevent contamination from neighboring checkout lanes.

In addition to utilizing an RFID scan tunnel at POS, the scan tunnel is utilized in other areas of the store other than the checkout aisle, where it is beneficial for multiple items to be read simultaneously. For example, an embodiment of the RFID enabled scan tunnel is placed near the fitting rooms in a store. This tunnel is used to generate stocking lists for items left in the fitting rooms by reading RFID tags on the products in the fitting room. These RFID tags indicate where their respective items are displayed and/or include identification information that can be used by the RFID scanner to retrieve information regarding the placement of the items from a local and/or an externally accessible memory resource. Based on the data read from the RFID tags of the items, these stocking lists contain location information for each item and generate a list for the user to follow in order to restock the items.

In addition to being oriented about a checkout lane and/or a fitting room, an embodiment of the present invention is oriented at an exit point of a retail establishment so that an individual can exit through the structure while carrying and/or carting items to be purchased.

In embodiments of the present invention, the shielding material is comprised on materials including but not limited to metal, opaque metal, and/or a transparent/translucent material. The coating includes nut is not limited to a transparent conductive coating, such as TCO and/or organic materials.

In an embodiment of the present invention, the RF reflective coating is an antenna of an RFID scanner.

### BRIEF DESCRIPTION OF DRAWINGS

FIG. 1 depicts an embodiment of one or more aspects of the present invention.

FIG. 2 depicts an embodiment of one or more aspects of the present invention.

FIG. 3 depicts an embodiment of one or more aspects of the present invention.

FIG. 4 depicts an embodiment of one or more aspects of the present invention.

FIG. 5 depicts an embodiment of one or more aspects of the present invention.

FIG. 6 depicts an embodiment of one or more aspects of the present invention.

### DETAILED DESCRIPTION OF THE INVENTION

The present invention provides a system and method for radio frequency identification (RFID) tracking for asset tracking, including at point of sale (POS).

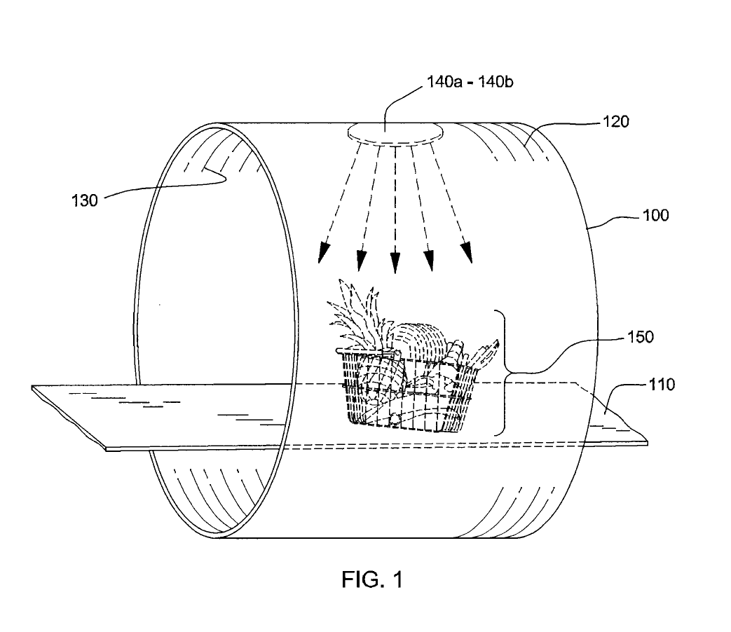

Referring to FIG. 1, an embodiment of the present invention utilizes a scan tunnel system comprising a checkout tunnel 100, which is a circular structure, surrounding a conveyer belt 110. The checkout tunnel 100 is covered on the outside with a thin metallic covering 120. The inside of the checkout tunnel 100 is coated with an RF reflecting material 130. This RF reflecting material 130 includes any electrically conductive material including, but not limited or restricted to metals (e.g., copper, aluminum, tin, silver, gold, etc.) or any polymer composite with conductive additives or coatings.

In this embodiment, at two RFID scanners 140a-140b are mounted in the checkout tunnel 100. Further embodiments of the present invention may contain one scanner or more than two scanners, depending on the size and type of merchandise being scanned. The placement of the RFID scanners 140a-140b within the tunnel will also vary in accordance with the type and size of the items being scanned.

As items pass on the conveyer belt 110, through the checkout tunnel 100, the RF reflecting material 130 reflects and scatters the RF signals from the RF scanners 140a-140b. Because the RF signals are scattered, the chance of reading the signals, emanating from the RFID tags (not pictured) on the items 150 increases, even if the items are obstructing each other or are in the cart, which can block the signal.

This scan tunnel contains RF signals (to avoid inadvertent reconciliations) and reflects RF signals internally within the scan tunnel. The reflection of the RF signals in the tunnel allows multiple passes of RF waves over the RFID tags of the items on the conveyer belt 110. The checkout tunnel blocks out RF tags from adjacent checkout lanes. In an embodiment of the present invention, the majority of the RFID tags on scanned items are read in one or two passes.

The outside material 130 prevents contamination from RF waves from neighboring checkout lanes. The reflective material inside the tunnel 120 creates an environment in which the RF signals reflect around and become multidirectional; due to the reflective nature, signals will strike tags from multiple directions and angles, increasing the chances for each individual tag to be read, including tags that are obscured from certain directions by environmental factors such as other tags and adjacent structures, such as the shopping cart.

The RFID scanners 140a-140b are coupled to the POS system (not pictured), so that a shopper can be charged for the items on the conveyer belt 100. The system may also be coupled to an inventory management system (not pictured) so that items that are scanned for purchase are deducted from inventory records.

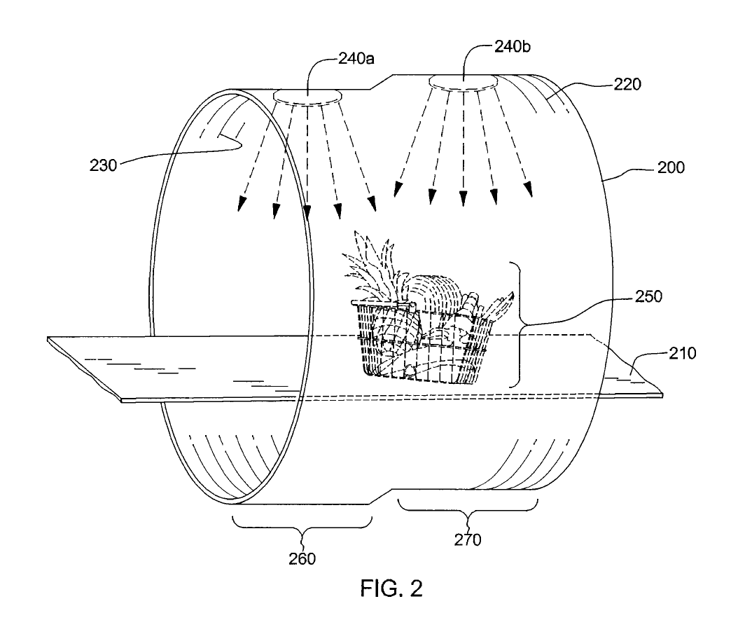

Referring to FIG. 2, in an embodiment of the present invention, the tunnel 200 has a first segment 260 and a second segment 270. The first segment 260 and the second segment 270 are off-set from each other. This positioning further decreases contamination with signals from neighboring tunnels. This scan tunnel 200 also features two RFID scanners 240a-240b. Each scanner is placed in its own scan tunnel 200 segment to encourage the reflection of the RF signals. This scan tunnel 200 is covered with a covering to decrease interference from other lanes, including but not limited to, a thin metallic covering 220. The inside of the scan tunnel 200 is coated with a material 230 to encourage reflection of RF signals and/or minimize absorption or signal loss. Items 250 on the conveyer belt 210 are scanned by the scanners 240a-240b with the assistance of the tunnel 200 in reflecting the signals so that obscured tags (not pictured) on the items 250 can be read.

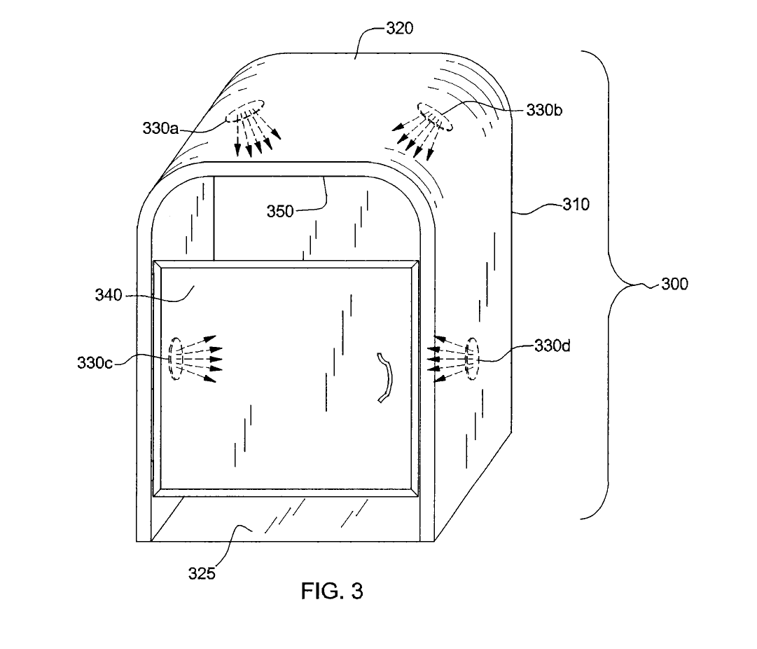

FIG. 3 is an embodiment of a scan tunnel 300 adapted for use in a fitting room in conjunction with recognizing the tagged items inside of the fitting room. This scan tunnel 300 can be used for checking inventory within the fitting room area and also as a theft prevention device.

As seen in FIG. 3, the fitting room stall 310 is enclosed by a ceiling 320, walls that stretch to the floor 325, and the floor 325 itself and complete the scan tunnel 300. Individuals within the fitting room stall 310 will have merchandise with them and leave some items within the fitting room. RFID scanners 330a-330n mounted within the scan tunnel 300 will read RFID tags on the merchandise. These RFID receivers 330a-330d communicate with an inventory management system (not pictured) over a network (not pictured). Thus, the items within the fitting room stall 310 can be tracked. Like the embodiment of FIG. 1, this scan tunnel 300 has an outer covering (e.g., a metallic covering) 340 to inhibit interference from RF signals from other stalls and an inner covering 350 comprised of a reflective material for scattering the RF signals to increase the chance of reading the tags on the merchandise within the tunnel 300, by reflecting the RF signals so that they strike the tags from different directions.

In an embodiment of the present invention, the information gleaned from reading tags within the fitting room stall 310 can be communicated to a computer system (not pictures) via a network connection (not pictured) and used to generate a restocking list. By understanding what items from each fitting room need to be restocked, the labor required to restock the store can be coordinated more effectively.

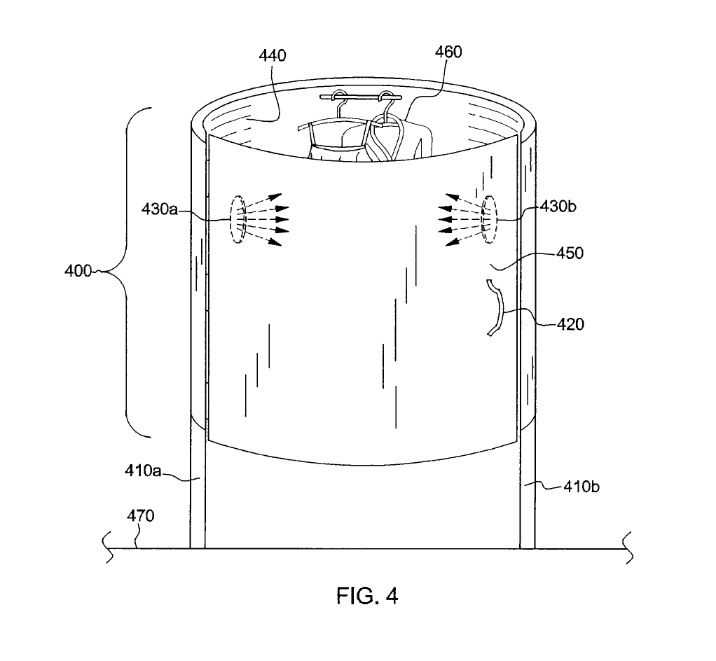

FIG. 4 is another fitting room stall that utilizes one or more aspects of an embodiment of the present invention. This design integrates more easily with the fitting room stalls in many stores. This fitting room stall comprises a scan tunnel 400. The tunnel 400 can be opened to enter with a door handle 420. Two RFID scanners 430a-430b are mounted within the tunnel 400. The two scanners 430a-430b are merely an example of an embodiment. Depending upon the shape and size of the stall, anywhere from one to many scanners may be most effective, functionally and/or cost-wise. The scan tunnel 400 and affixed to the floor 470 with legs 410a-410b. The outside of the scan tunnel 400 is coated with a covering 450 to limit interference from neighboring stalls while the inside has a reflective coating 440 that reflects RF signals to increase scanning efficacy. The merchandise within the scan tunnel 400 may be hung on a fixture 460 in the scan tunnel 400 or it may be discarded in other places in the scan tunnel 400. Due to the reflective nature of the tunnel, RFID tags on merchandise that is not placed in ideal scanning radii will still be read by the RFID scanners 430a-430b.

The material comprising the covering 450 in this embodiment, as well as in further embodiments, includes but is not limited to opaque metal, and/or a transparent/translucent material. The material comprising the reflective coating 440 in this embodiment in addition to further embodiments includes but is not limited to a transparent conductive coating, such as TCO or organic materials. In an embodiment of the present invention, the internal RF reflective coating is an antenna of an RFID scanner.

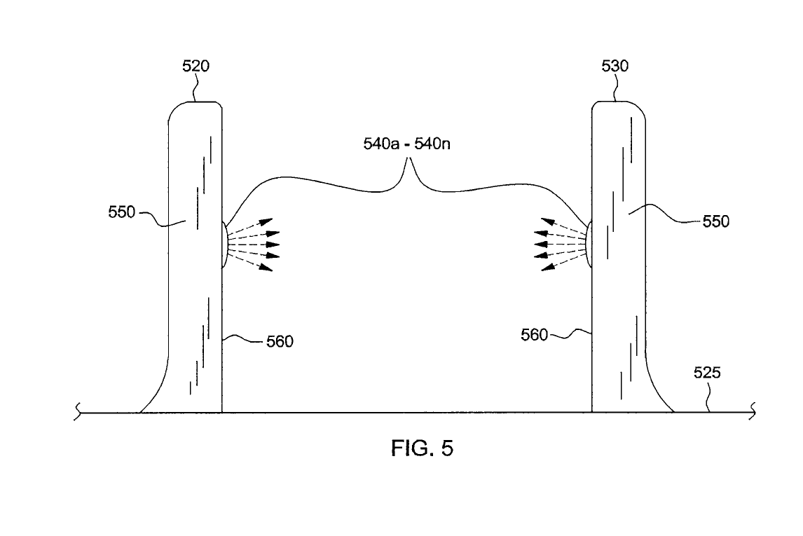

FIG. 5 is a variation of the scan tunnel 100 of FIG. 1. In FIG. 5, Rather than surround the checkout lane 510, a first panel 520 and a second panel 530 are situated opposite each other. In this embodiment, the panels 520, 530, are situated parallel to the checkout on either side of the lane 525. In a further embodiment of the present invention, the panels are situated perpendicular to the lane. In a further embodiment of the present invention, the panels are situated above and below the lane. RFID scanners 540a-n are positioned on one or more of the panels 520, 530. The outside of the panels 520, 530, are coated with a covering 550 to limit interference from neighboring lanes while the inside of each panel has a reflective coating 560 that reflects RF signals to increase scanning efficacy.

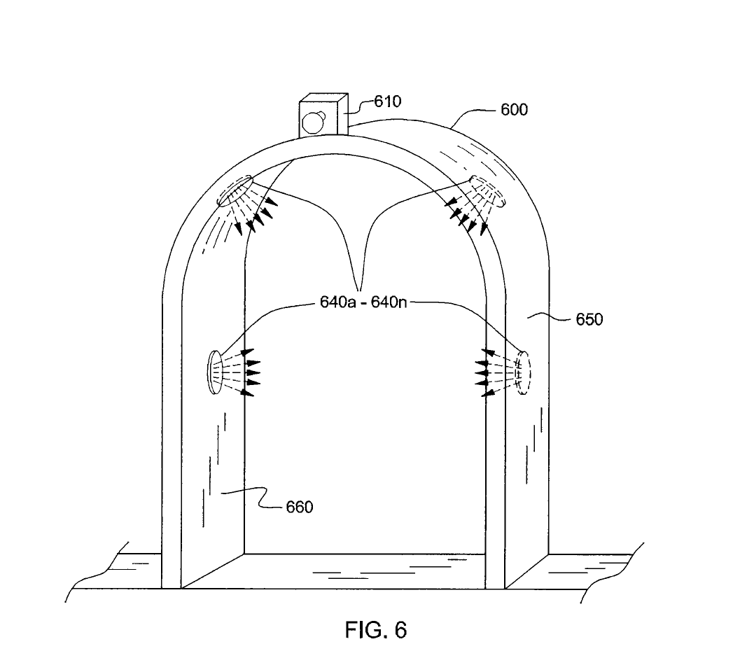

The embodiment of FIG. 6 positions a scan tunnel 600 in the exit path of a retail establishment. Utilizing this scan tunnel, customers can load up their shopping carts and/or baskets and walk right out of the store. The customer is identified before entering the tunnel, for example, using an id card or a credit and/or debit card, and then the items in the cart are scanned and the data is sent to a POS system, which charges the an account, for example, the account associated with the credit card swiped upon entry to the scan tunnel 600. To prevent multiple people from entering the scan tunnel 600, an indicator, in this embodiment a green light 610, is mounted atop the scan tunnel 600. Those skilled in the art will recognize that many mechanism can be used to prevent too many individuals from entering the tunnel 600 before a read is complete. For example, a further embodiment utilizes a gate that opens and closes depending upon whether the scan tunnel 600 is in use or ready to receive a new customer.

RFID scanners 640a-n are positioned in the scan tunnel 600. The outside of the tunnel 600 is coated with a covering 650 to limit interference from neighboring lanes while the inside of the tunnel has a reflective coating 660 that reflects RF signals to increase scanning efficacy.

The scan tunnel 600 can be configured as separate panels, a larger scale of the embodiment of FIG. 5. In this embodiment, panels can be placed on two opposite sides of a customer or above and below the customer.

Although the present invention has been described in relation to particular embodiments thereof, many other variations and modifications will become apparent to those skilled in the art. As such, it will be readily evident to one of skill in the art based on the detailed description of certain embodiments explained herein, that different embodiments can be realized.

1. An apparatus for reading RFID tags, said apparatus comprising:
a structure having an inner surface and an outer surface and a lateral input opening and a lateral output opening; and
an RFID scanner mounted on the inner surface of said structure;
wherein said structure is positioned to enclose at least two sides of a lane; and
wherein items entering said lane enter said structure via the lateral input opening and exit via the lateral output opening.

2. The apparatus of claim 1, wherein said inner surface is comprised of a material that reflects RF waves from said RFID scanner.

3. The apparatus of claim 1, wherein said outer surface is comprised of a covering that shields the area inside the structure from RF signals.

4. The apparatus of claim 1, further comprising a second RFID scanner mounted on the inner surface of said structure.

5. The apparatus of claim 1, further comprising a plurality of RFID scanners mounted on the inner surface of said structure.

6. The apparatus of claim 1, wherein said structure is comprised of a first portion and a second portion and wherein said first portion is off-set from said second portion.

7. The apparatus of claim 1, wherein said structure is a spherical enclosure.

8. The apparatus of claim 1, further comprising a plurality of RFID scanners mounted on the inner surface of said structure.

9. The apparatus of claim 1, wherein said structure is comprised of two panels situated parallel to each other.

10. The apparatus of claim 1, wherein said lane comprises one of: a conveyer belt, a fitting room, a human pathway.

11. A method for scanning items utilizing an apparatus comprising an structure having an inner surface and an outer surface and a lateral input opening and a lateral output opening; and
an RFID scanner mounted on the inner surface of said structure;
wherein said structure is positioned to encircle a lane; and
wherein items entering on said lane enter said structure via the lateral input opening and exit via the lateral output opening, said method comprising:
advancing RFID tagged items in said lane through said lateral input opening into said structure;
reading said tags on said RFID tagged items.

12. The method of claim 11, wherein said inner surface of said structure is comprised of a material that reflects RF waves from said RFID scanner.

13. The method of claim 11, wherein said outer surface of said structure is comprised of a metallic covering.

14. The method of claim 11, wherein said apparatus further comprises a second RFID scanner mounted on the inner surface of said structure.

15. The method of claim 11, wherein said apparatus further comprises a plurality of RFID scanners mounted on the inner surface of said structure.

16. The method of claim 11, wherein said structure is comprised of a first portion and a second portion and wherein said first portion is off-set from said second portion.

17. The method of claim 11, wherein said structure is a spherical enclosure.

18. The method of claim 11, wherein said apparatus further comprises a plurality of RFID scanners mounted on the inner surface of said structure.

19. The method of claim 11, wherein said structure is comprised of two panels situated parallel to each other.

20. The method of claim 11, wherein said lane comprises one of:
a conveyer belt, a fitting room, a human pathway.
